(19) United States
(12) Patent Application Publication
(10) Pub. No.: US 2013/0309593 A1
(43) Pub. Date: Nov. 21, 2013

(54) GASEOUS DIFFUSION LAYER FOR FUEL CELL

(71) Applicant: Commissariat A L'Energie Atomique Et Aux Energie Alternatives, Paris (FR)

(72) Inventors: Ludovic ROUILLON, Villard De Lans (FR); Joël PAUCHET, Saint Martin D'Uriage (FR)

(73) Assignee: Commissariat A L'Energie Atomique Et Aux Energie Alternatives, Paris (FR)

(21) Appl. No.: 13/897,686

(22) Filed: May 20, 2013

Related U.S. Application Data
(63) Continuation of application No. PCT/FR2011/052232, filed on Sep. 26, 2011.

(30) Foreign Application Priority Data
Dec. 9, 2010 (FR) 10.60282

(51) Int. Cl. H01M 8/10

(52) U.S. Cl. CPC H01M 8/1002
USPC 429/480; 429/513; 429/535

(57) ABSTRACT

This gas diffusion layer for a PEMFC includes at least one hydrophilic electronically-conductive thread, advantageously formed of a carbon thread, of an electronically conductive hydrophilic material thread, or of a polymer thread loaded with electronically-conductive particles.

### FIELD OF THE INVENTION

The present invention relates to a gas diffusion layer (or GDL) for a proton exchange membrane fuel cell (PEMFC), comprising a hydrophilic electronically-conductive thread in its structure.

The field of use of the present invention is relative to that of PEMFCs, and thus to applications generally concerning current generators.

### BACKGROUND OF THE INVENTION

Proton exchange membrane fuel cells (PEMFC) are current generators based on the conversion of chemical energy into electric energy by catalytic reaction of the reactants (FIGS. 1 and 2).

Membrane-electrode assemblies 1 (MEA), commonly called cell cores, form the basic elements of PEMFCs. They are formed of a polymer membrane 2 and of catalyst beds 3, 4 present on either side of the membrane. Membrane 2 thus enables to separate anode and cathode compartments 5 and 6. Catalyst beds 3, 4 are generally formed of platinum nanoparticles supported on carbon clusters.

Further, gaseous diffusion layers 7, 8 or GDL, typically made of carbon fabric or carbon felt, are arranged on either side of MEA 1 to provide:
(1) the electric conduction;
(2) the homogeneous incoming of reactant gases via a channel system 9, 10; and
(3) the discharge of the excess gases and of the water produced at cathode 4.

In the specific case where the reactants are hydrogen and oxygen (FIG. 3), at anode 3, the decomposition of the hydrogen adsorbed on the catalyst produces H⁺ protons and electrons e⁻ according to the following reaction:

H₂→2H⁺+2 e⁻

The protons then cross polymer membrane 2 before reacting with oxygen at cathode 4. The reaction of the protons with oxygen at the cathode causes the forming of water and the production of heat:

O₂+4H⁺+4 e⁻→2H₂O

Given that the ion conductivity of polymer membrane 2 depends on its water content, controlling the management of water within the PEMFC thus appears to be essential. Indeed, the membrane must be sufficiently humidified to provide a good ion conductivity, not too much however, to avoid a clogging of catalyst sites. The presence of too large a quantity of liquid water can then considerably decrease the power conversion efficiency, since it is then difficult for gases to access the reaction sites.

Solutions have been provided to discharge the water produced at cathode 4, or to supply the MEA by injection of water on the side of anode 3.

Thus, prior art comprises various methods intended to limit the clogging of the porous components of the diffusion layer, such as for example the application of a hydrophobic PTFE processing. Such a processing of the porous components may be a volume or surface processing.

Other studies have shown an improvement of the water management in a PEMFC due to a laser perforation of the gas diffusion layer (D. Gerteisen, T. Heilmann, C. Ziegler, “Enhancing liquid water transport by laser perforation of a GDL in a PEM fuel cell”, Journal of Power Sources 177 (2008) 348-354). In this document, the gas diffusion layer is perforated at the cathode to enable to discharge the water produced at the PEMFC cathode.

Further, U.S. Pat. No. 5,952,119 describes a PEMFC having its hydrophobic diffusion layer crossed in places by a hydrophilic thread which is not electronically conductive. This thread may especially be formed of a polyester core covered with Nafion®, Nafion® being a polymer conducting protons, but not electrons. Thus, the hydrophilic thread enables to supply the membrane with water, by water injection on the anode side of the PEMFC. This document thus relates to the water supply of the PEMFC at the anode, and this, to maintain the membrane hydration and allow it to operate in optimal conditions, especially at temperatures approximately ranging from 80 to 90° C.

In document U.S. Pat. No. 5,952,119, the needle holes generated on incorporation of the hydrophilic thread are closed by compression of the anode compartment.

There however is a persistent need to develop technical solutions enabling to improve the water management in a cell and thus to improve its performance.

### BRIEF DESCRIPTION OF THE DRAWINGS

FIG. 1 shows the diagram of the operating principle of a PEMFC fuel cell.

FIG. 2 shows the diagram of the operating principle of the MEA of a PEMFC.

FIG. 3 illustrates the operation of a PEMFC when the reactants are oxygen at the cathode and hydrogen at the anode.

FIG. 4 shows a cross-section view of a diffusion layer, as well as a close-up view of a portion of said diffusion layer.

FIG. 5 shows a cross-section view of a diffusion layer comprising a hydrophilic electronically-conductive thread according to the invention. A close-up of a portion of said diffusion layer shows the effects of the introduction of said thread on the structure of the diffusion layer, and especially of surface fuzz.

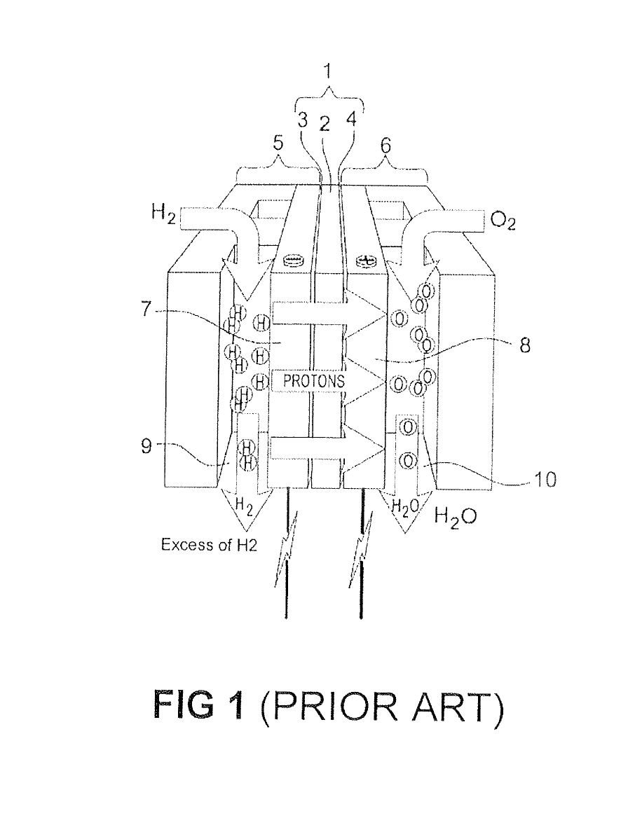

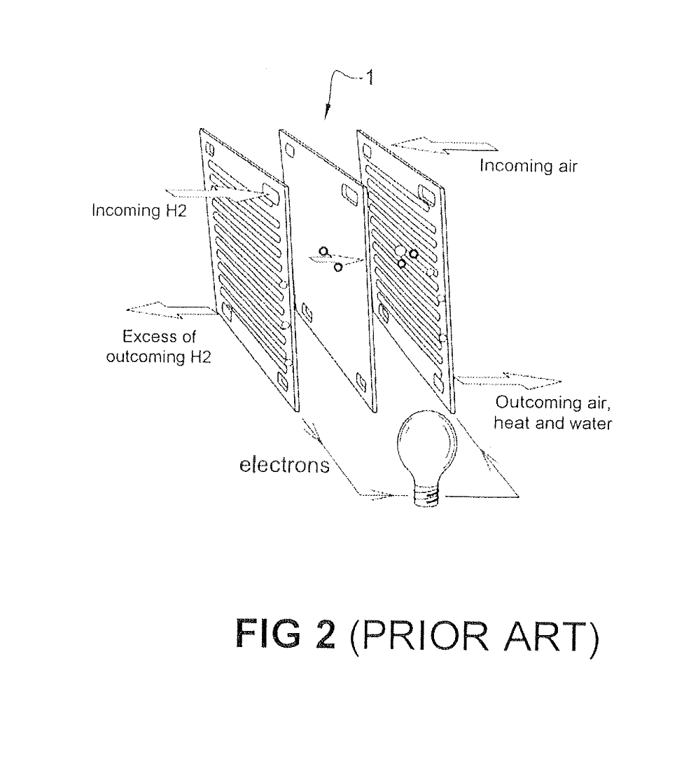

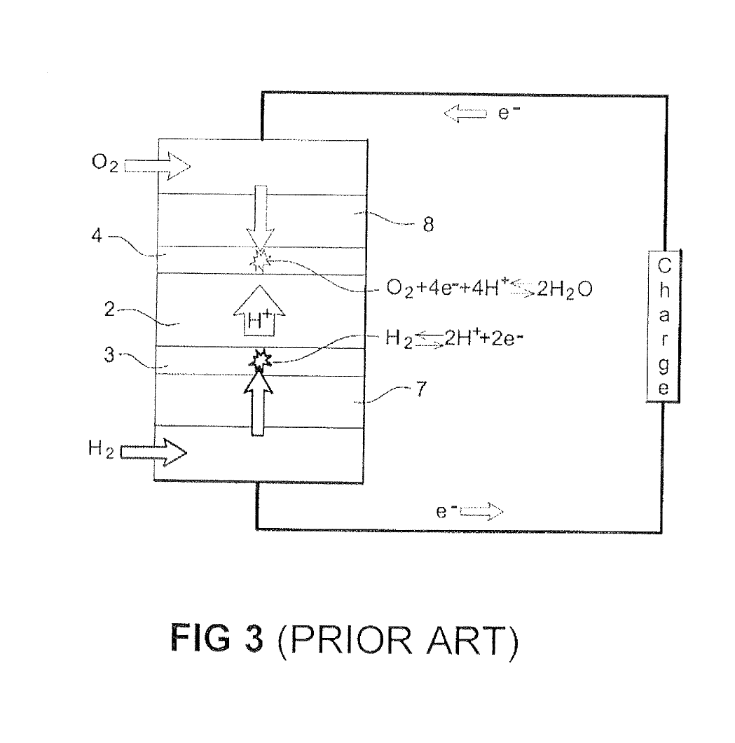

### DETAILED DESCRIPTION OF THE INVENTION

Thus, the Applicant has developed a gas diffusion layer for a PEMFC enabling, at the same time, to:
discharge the liquid water produced by the electrochemical cathode reaction;
maintain the homogeneous membrane hydration; and
improve the thermal and electric properties of gas diffusion layers.

More specifically, the present invention relates to a PEMFC gas diffusion layer, comprising at least one electronically conductive hydrophilic thread in its structure, said thread being positioned substantially perpendicularly to the surface of the diffusion layer and thus, eventually, in the final structure, to the MEA.

As a reminder, a PEMFC comprises a polymer membrane and catalyst beds present on either side of the membrane forming the membrane-electrode assembly (MEA). Further, gas diffusion layers are arranged on either side of the MEA.

Generally, a gas diffusion layer is made of a porous electronically-conductive material. It may be formed of carbon fabric, of carbon felt, of carbon paper, of graphite.

In a specific embodiment, the gas diffusion layer may be made of metal, or of a polymer loaded with electronically conductive particles. Said polymer may be a polycarbonate, polypropylene, polyvinylidene fluoride, or a phenolic resin.

The metal and the loads may advantageously be selected from the group comprising gold, platinum, nickel, titanium, aluminum, stainless steel, silver, and more advantageously still gold, silver, and titanium.

A GDL (gas diffusion layer) according to the present invention has a thickness advantageously ranging between 100 and 500 micrometers.

As already mentioned, and typically, said layer comprises a thread made of a hydrophilic electronically-conductive material.

In the context of the present invention, electronically conductive means a material having a resistivity preferably smaller than 1.3 mohm.cm.

Further, hydrophilic qualifies a material capable of draining liquid water by capillary effect.

For more clarity in the following description, thread means an electronically-conductive hydrophilic thread.

The conductive hydrophilic thread of the gas diffusion layer is selected to avoid affecting the chemical stability of the fuel cell, of its components and reactants. It may be selected from the group comprising carbon threads, metal wires (gold, silver, for example, or any electrically conductive hydrophilic material), or polymer threads loaded with electronically-conductive particles. Said polymers may be polycarbonates, polypropylenes, polyvinylidene fluoride, or a phenolic resin.

Further, the loads may advantageously be selected from the group comprising gold, platinum, nickel, titanium, aluminum, stainless steel, silver, and more advantageously gold, silver, and titanium.

The hydrophilic electronically-conductive thread advantageously is a carbon thread.

Typically, the hydrophilic electronically-conductive thread has a diameter ranging between 10 and 100 micrometers, more advantageously between 45 and 55 micrometers, and more advantageously still on the order of 50 micrometers. Such dimensions thus enable to limit overthicknesses which may possibly result from the presence of a thread in the GDL.

It should however be noted that the diameter of the holes generated by a needle on insertion of the hydrophilic electronically-conductive thread is generally from two to four times greater than the diameter of said thread.

Advantageously, at least one plane of the gas diffusion layer comprises the thread(s); said planes being inscribed within the thickness of the gas diffusion layer. Preferably, the thread is positioned substantially perpendicularly to the surface of the gas diffusion layer and, thus, in the cell, to the MEA.

According to a preferred embodiment, the hydrophilic electronically-conductive thread is homogeneously or heterogeneously distributed on the surface of the GDL (gas diffusion layer).

Advantageously, the thread is distributed across the thickness of the gas diffusion layer, in a zigzag or square course, continuously or discontinuously, randomly, or periodically. The thread is advantageously positioned to follow the structure of the channels supplying the reactant gases of the PEMFC.

The diffusion layer may comprise one or several threads which may cross the thickness of the gas diffusion layer. According to a specific embodiment, threads of different nature or size may be interposed in the gas diffusion layer.

The distance, on the surface of the GDL, between each thread or thread portion, advantageously ranges between 0.4 and 1 mm.

Advantageously, the surface area of the gas diffusion layer modified by the thread amounts to from 1 to 50%, and advantageously from 1 to 20% of the total surface area of the gas diffusion layer. In other words, the holes generated by the needle on insertion of the hydrophilic electronically-conductive thread amount to from 1 to 50% of the total surface area of the GDL, and more advantageously still from 1 to 20%.

Thus, and according to a specific embodiment, the gas diffusion layer of a PEMFC comprises a carbon thread, so that the surface area modified by the carbon thread amounts to from 1 to 20% of the total surface area of the plane of the gas diffusion layer comprising the thread for:
an operating temperature of the PEMFC ranging between 60 and 80° C.; and
a current density ranging between 0.1 and 1.2 A/cm², preferably equal to 0.5 A/cm²; and
a pressure ranging between 1 and 2 bars, preferably equal to 1.5 bars.

Indeed, such conditions, especially this thread insertion density, enable to reach an equilibrium between the membrane hydration and the humidification rate of the reactant gases of the PEMFC.

The present invention also relates to the method for forming a gas diffusion layer comprising at least one hydrophilic electronically-conductive thread, according to which a step of structuring of the gas diffusion layer is carried out by sewing by means of at least one hydrophilic electronically-conductive thread.

Said thread is preferably distributed across the thickness of the gas diffusion layer by a method close to that used to manufacture carbon nonwovens or glass fibers in aeronautic applications.

In a specific embodiment, the thread is advantageously mechanically introduced into the thickness of the gas diffusion layer, substantially perpendicularly to the MEA, by sewing. The thread can thus cross the porous component forming the gas diffusion layer and perform the bonding by sewing.

Advantageously, the thread is introduced into the thickness of the gas diffusion layer, in a zigzag or square course, continuously or discontinuously, randomly, or periodically.

The use in a PEMFC of the gas diffusion layer such as described hereabove or obtained according to the above method also falls within the framework of the present invention.

Thus, and according to another aspect, the present invention also relates to a PEMFC also comprising a gas diffusion layer such as described hereabove.

A PEMFC according to the invention comprises at least one gas diffusion layer such as described hereabove, in contact either with the anode, or with the cathode. Advantageously, the PEMFC comprises two GDLs according to the invention, one being in contact with the cathode and the other being in contact with the anode. Thus, the discharge of the water produced at the cathode, the maintaining of the membrane hydration, and fine gas exchanges are promoted.

Advantageously, the PEMFC comprises a GDL according to the invention in contact with the cathode.

Preferably, the hydrophilic electronically-conductive thread used in the context of the present invention is not intended to supply the anode with water.

As a summary, the present invention provides a gas diffusion layer for a PEMFC-type fuel cell having improved properties with respect to prior art, in terms of:
reactant gas supply on the catalyst beds;
electric and thermal connection between the active area (catalyst bed) and the current conduction plates (current collector);
discharge of the water produced by the cathode reduction reaction, without for all this drying the membrane.

Indeed, the structuring of the gas diffusion layer by means of a hydrophilic electronically-conductive thread enables to homogenize the reactant gas supply on the electrode surface. A greater part of the catalyst, deposited at the membrane surface, is thus supplied with reactant gases. Such a distribution thus limits hot spot problems due to the exothermicity of the electrochemical reaction. Further, the mechanical damage due to the introduction of the thread creates a hole or a privileged pathway for gases, across the thickness of the gas diffusion layer.

Further, the improvement of electric and thermal connections between the active area and the current conduction plates is promoted by the hydrophilic electronically-conductive thread, which has higher thermal and electric conductivities in the longitudinal direction than in the transverse direction. The mechanical damage due to the introduction of said thread creates surface fuzz, thus improving electric contact resistances between interfaces.

Finally, the thread, together with the presence of a hole or cavity in the plane comprising the thread, favors a capillary rise. As a result, the membrane hydration is homogenized, thus avoiding clogging problems. An equilibrium is naturally achieved via the hydrophilic thread, between the membrane hydration level and the humidification rate of the reactant gases flowing through the channels of the bipolar plates, the excess liquid water being further discharged through the reactant gas supply channels.

1. A gas diffusion layer of a PEMFC, comprising at least one hydrophilic electronically-conductive thread positioned substantially perpendicularly to the surface of the gas diffusion layer.

2. The gas diffusion layer of claim 1, wherein it is made of carbon fabric, carbon felt, carbon paper, graphite.

3. The gas diffusion layer of claim 1, wherein the thread is selected from the group comprising carbon threads, threads of hydrophilic electrically-conductive material, or polymer threads loaded with electronically-conductive particles.

4. The gas diffusion layer of claim 3, wherein the thread is a carbon thread.

5. The gas diffusion layer of claim 1, wherein the thread has a diameter ranging between 10 and 100 micrometers, more advantageously between 45 and 55 micrometers.

6. The gas diffusion layer of claim 1, wherein the thread is positioned to follow the structure of the channels for supplying reactant gases of the PEMFC.

7. The gas diffusion layer of claim 1, wherein the gas diffusion layer has a surface area modified by the introduction of the thread equal to from 1 to 50%, and advantageously from 1 to 20% of the total surface area of the gas diffusion layer.

8. A method for forming the gas diffusion layer of claim 1, wherein it comprises a step of structuring of the gas diffusion layer performed by sewing by means of at least one hydrophilic electronically-conductive thread.

9. A PEMFC comprising at least one gas diffusion layer Of claim 1.

10. The PEMFC of claim 9, wherein it comprises a gas diffusion layer in contact with the cathode of the PEMFC.
